(19) United States
(12) Patent Application Publication
(10) Pub. No.: US 2015/0235116 A1
(43) Pub. Date: Aug. 20, 2015

(54) PRINTING APPARATUS

(71) Applicant: CANON KABUSHIKI KAISHA, Tokyo (JP)

(72) Inventor: Masanobu Inui, Chigasaki-shi (JP)

(21) Appl. No.: 14/625,225

(22) Filed: Feb. 18, 2015

(30) Foreign Application Priority Data
Feb. 19, 2014 (JP) 2014-029733

(51) Int. Cl. G06K 15/00; B65H 7/20; B65H 1/28

(52) U.S. Cl. CPC G06K 15/4065; B65H 1/28; B65H 7/20

(57) ABSTRACT

There is provided a printing apparatus which identifies the size of a sheet indicated by the guide of a feeding cassette and displays a warning screen if the identified size of the sheet is not included in the size group set to the feeding cassette.

### BACKGROUND OF THE INVENTION

1. Field of the Invention

The present invention relates to a printing apparatus.

2. Description of the Related Art

The printing apparatus includes a feeding cassette, feeds a sheet stored in the feeding cassette one by one, and executes printing. The printing apparatus needs to identify the size of the sheet before executing printing. Therefore, the feeding cassette of the printing apparatus is provided with a detection mechanism for automatically detecting the size of the sheet. The use of the detection mechanism allows the printing apparatus to identify the size of the sheet stored in the feeding cassette.

Japanese Patent Application Laid-Open No. 5-186056 discusses a configuration of the detection mechanism for automatically detecting the size of the sheet in which a guide plate on which a plurality of holes is arranged and a sensor for detecting the holes of the guide plate are provided on the side face of the feeding cassette.

Japanese Patent Application Laid-Open No. 2011-031995 discusses a configuration in which a guide for fixing the sheet is provided on the feeding cassette and the printing apparatus identifies the size of the sheet based on the position of the guide.

When the size of the sheet is identified by using the guide of the feeding cassette, a user needs to move the guide to a predetermined size position. For example, if the user wants to print on an A4-size sheet, the user needs to move the guide of the feeding cassette to an A4 position indicating the A4 size.

However, if the printing apparatus handles both of the A4-size sheet and a letter paper (hereinafter referred to as LTR) which is substantially equal in size to the A4-size sheet, for example, a problem arises. Because the A4 and the LTR are substantially equal in size to each other, the A4 position indicating the A4 and an LTR position indicating the LTR are provided very close to each other. Therefore, if the user wants to print on the A4-size sheet, for example, the user may be misled into thinking that the A4-size sheet is already stored even though the guide actually lies in the LTR position. If the size of the sheet does not fit well with the position of the guide, feeding of the sheet is liable to be unstable, which can cause sheet jam or printing failure.

### SUMMARY OF THE INVENTION

The present invention is directed to making the user aware that the guide for detecting the size of the sheet lies in an inappropriate position.

According to an aspect of the present invention, a printing apparatus includes a sheet holding unit including a movable guide and configured to hold a sheet, a setting unit configured to set a size group covering a plurality of sheet sizes as one group to the sheet holding unit, a determination unit configured to determine whether the sheet size identified by the guide is included in the size group set by the setting unit, and a notification unit configured to notify a user of a predetermined information if the determination unit determines that the sheet size identified by the guide is not included in the size group.

Further features of the present invention will become apparent from the following description of exemplary embodiments with reference to the attached drawings.

### BRIEF DESCRIPTION OF THE DRAWINGS

FIGS. 1A and 1B illustrate a configuration of a printing apparatus.

FIG. 2 illustrates a feeding cassette.

FIGS. 3A and 3B illustrate a setting screen for setting a size group and a table respectively.

FIG. 4 is a flow chart illustrating processing executed when the feeding cassette is closed.

FIG. 5 illustrates a warning screen.

FIGS. 6A, 6B, and 6C illustrate screen transition.

FIG. 7 is a flow chart executed at the time of changing the setting of the size group.

FIGS. 8A and 8B illustrate a modification example of a setting screen for setting the size group.

### DESCRIPTION OF THE EMBODIMENTS

Exemplary embodiments for carrying out the present invention are described below with reference to the accompanying drawings. The following exemplary embodiments do not limit the present invention according to the claims and not all combinations of features described in the exemplary embodiments are essential as solving means in the invention.

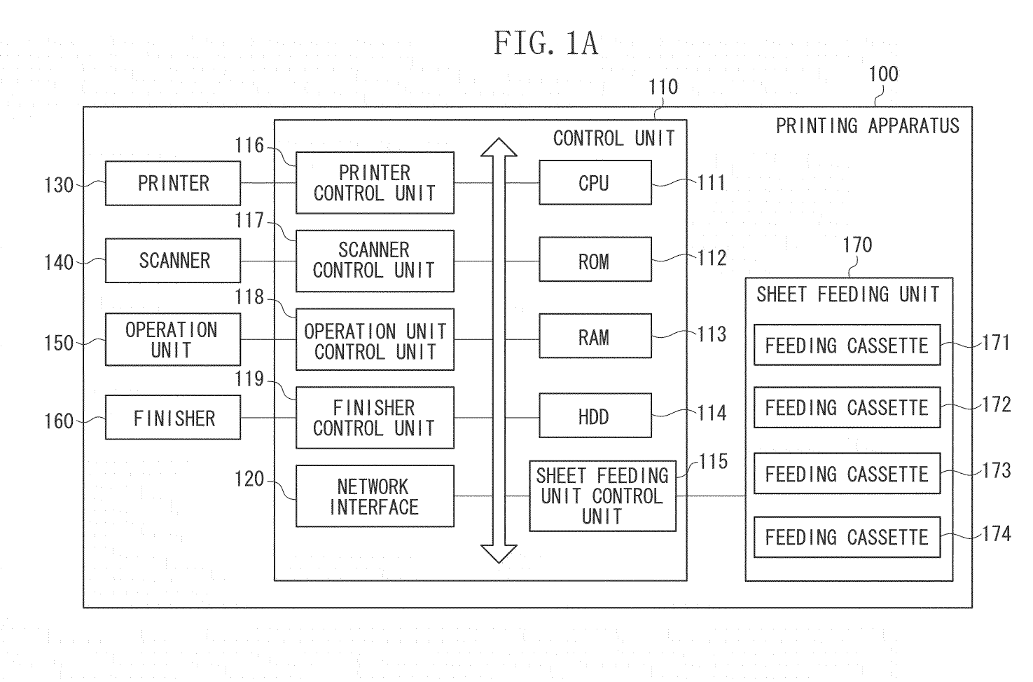

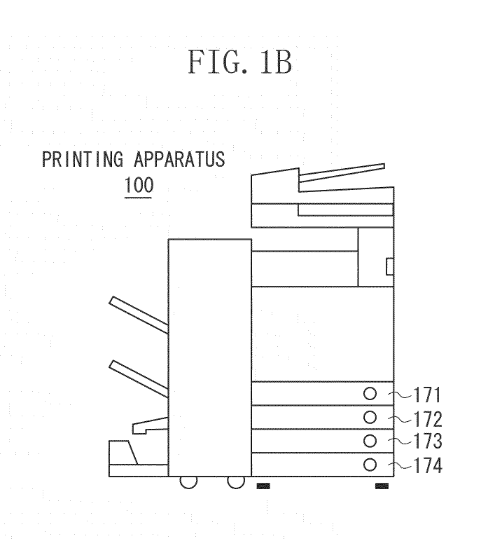

A first exemplary embodiment is described below. A hardware configuration of a printing apparatus 100 is described below with reference to FIG. 1A. The printing apparatus 100 is an example of a sheet control apparatus for controlling a sheet. In the present exemplary embodiment, the printing apparatus 100 is described as one apparatus, however, a sheet control system composed of a plurality of apparatuses may realize functions and processing similar to the printing apparatus 100.

A control unit 110 controls the operation of the entire printing apparatus 100. A hardware configuration of the control unit 110 is described in more detail below.

A central processing unit (CPU) 111 reads control programs stored in a read only memory (ROM) 112 and executes various processing for controlling the operation of the printing apparatus 100. The ROM 112 stores the control programs. A random access memory (RAM) 113 is used as a temporary storage area such as a main memory and a work area of the CPU 111. A hard disk drive (HDD) 114 stores various data such as a scan image and user setting.

In the printing apparatus 100, one CPU 111 executes each processing illustrated in a flow chart described below, however, other modes may be used. For example, a plurality of CPUs may collaborate with each other to execute each processing illustrated in the flow chart described below.

A sheet feeding unit control unit 115 connects a sheet feeding unit 170 with the control unit 110 to control the operation of the sheet feeding unit 170. A printer control unit 116 connects a printer 130 with the control unit 110 to control the operation of the printer 130. A scanner control unit 117 connects a scanner 140 with the control unit 110 to control the operation of the scanner 140. An operation unit control unit 118 connects an operation unit 150 with the control unit 110 to control the operation of the operation unit 150. A finisher control unit 119 connects a finisher 160 with the control unit 110 to control the operation of the fishier 160. A network interface 120 executes communication with an external apparatus such as a web server and a personal computer (PC) via a network not illustrated.

A printer 130 executes printing on the sheet based on a print job received from the external apparatus or print data such as a scan image generated by the scanner 140. The sheet on which printing is executed is fed from any of feeding cassettes of the sheet feeding unit 170. The scanner 140 reads a document to generate a scan image. The scan image generated by the scanner 140 is printed by the printer 130 or stored in the HDD 114.

The operation unit 150 includes a liquid crystal display unit with a touch panel function and a keyboard. A user can input instructions and information to the printing apparatus 100 via the operation unit 150.

The finisher 160 applies post-processing to the sheet on which printing is executed by the printer 130. There are various types of the post processing such as stapling, saddle stitch bookbinding, case bookbinding, and others. The type of the post processing is not limited in the present exemplary embodiment.

The sheet feeding unit 170 feeds a sheet stored in the feeding cassettes and conveys the fed sheet to the printer 130. The printing apparatus 100 is provided with four feeding cassettes 171, 172, 173, and 174, however, the number of the feeding cassettes is not limited to four. The sheet feeding unit 170 detects opening and closing of the feeding cassette. The sheet feeding unit 170 notifies the control unit 110 that the feeding cassette is opened and closed via the sheet feeding unit control unit 115. The sheet feeding unit 170 also notifies the control unit 110 of the size of the sheet stored in each feeding cassette (that is, the size of the sheet indicated by a guide of the feeding cassette described below) via the sheet feeding unit control unit 115.

FIG. 1B illustrates an external view of the printing apparatus 100. The feeding cassettes 171 to 174 can be opened and closed and the user stores a desired sheet to be used for printing in any of the feeding cassettes 171 to 174. The feeding cassette holds the sheet stored by the user and the printer 130 feeds the sheet held by the feeding cassette and executes printing thereon.

In the present exemplary embodiment, the feeding cassette is provided with a detection mechanism for detecting the size of the sheet stored in the feeding cassette. The following describes the detection mechanism.

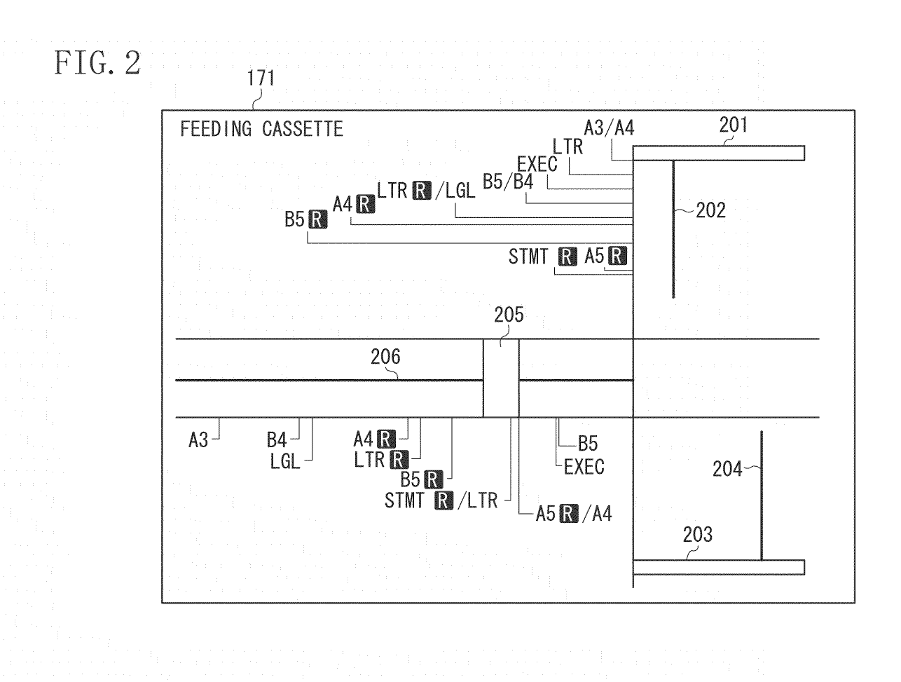

FIG. 2 is a top view of the feeding cassette. Although the feeding cassette 171 is described as an example in FIG. 2, the feeding cassettes 172 to 174 are also configured similar to the feeding cassette 171.

The feeding cassette 171 includes guides 201, 203, and 205 for fixing sheets. The user moves the guides to size positions corresponding to the size of a sheet and stores a desired sheet in the feeding cassette 171. The user can move the guides 201, 203, and 205 along rails 202, 204, and 206 respectively. The guide 201 is moved together with the guide 203. If the user moves one of the guides 201 and 203, the other guide is also moved.

The feeding cassette 171 is provided with a sensor (not illustrated) for identifying the size positions of the guides 201, 203, and 205. The printing apparatus 100 can identify the size of the sheet stored in the feeding cassette 171 based on the size position indicated by the sensor. The method for identifying the size of the sheet stored in the feeding cassette is not limited to the method described in the present exemplary embodiment. Other known techniques may be used. For example, the size of the sheet stored in the feeding cassette may be identified using a switch operated together with the move of the guide.

As can be seen in FIG. 2, there are many types of the sheet size and size positions as well. For this reason, the user may be misled into thinking that the guide lies in the size position intended by the user even though the guide actually lies in the size position unintended by the user.

For example, the size positions of the A4 and the LTR are very close to each other. For this reason, when the user who wants to print on the A4-size sheet confirms the feeding cassette, the user may be misled into thinking that the A4-size sheet is already stored in the feeding cassette even though the guide actually lies in the LTR position.

As described above, if a large number of the size positions are provided on the feeding cassette as illustrated in FIG. 2, the user may be mislead into thinking that the guide lies in an appropriate size position even though the guide actually lies in the size position unintended by the user. The present exemplary embodiment aims to urge the thus misled user to confirm the guide of the feeding cassette.

The size of the sheet is described below. Series A (A3 and A4, for example) and series B (B3 and B4, for example) defined in International Organization for Standardization (ISO) 216 are generally known as the size of the sheet. In North America including USA and Canada, LTR, Executive (hereinafter referred to as EXEC), Legal (hereinafter referred to as LGL), Statement Half Letter (hereinafter referred to as STMT) are used. As illustrated in FIG. 2, the feeding cassette of the printing apparatus 100 is adapted to those various sizes and therefore a larger number of size positions are provided. Hereinafter, the series A and B are collectively referred to as “AB size” and handled as one size group. The LTR, EXEC, LGL, and STMT are collectively referred to as “inch size” and handled as another size group different from the AB size.

Whether a sheet with the size included in the AB size is used or a sheet with the size included in the inch size is used is generally determined depending on a place where the printing apparatus is installed. A Japanese company, for example, often uses the AB size but an American company often uses the inch size. In the present exemplary embodiment, a size group of the AB size or the inch size is set to the feeding cassette to cause the user to be aware that the guide of the feeding cassette lies in an inappropriate size position.

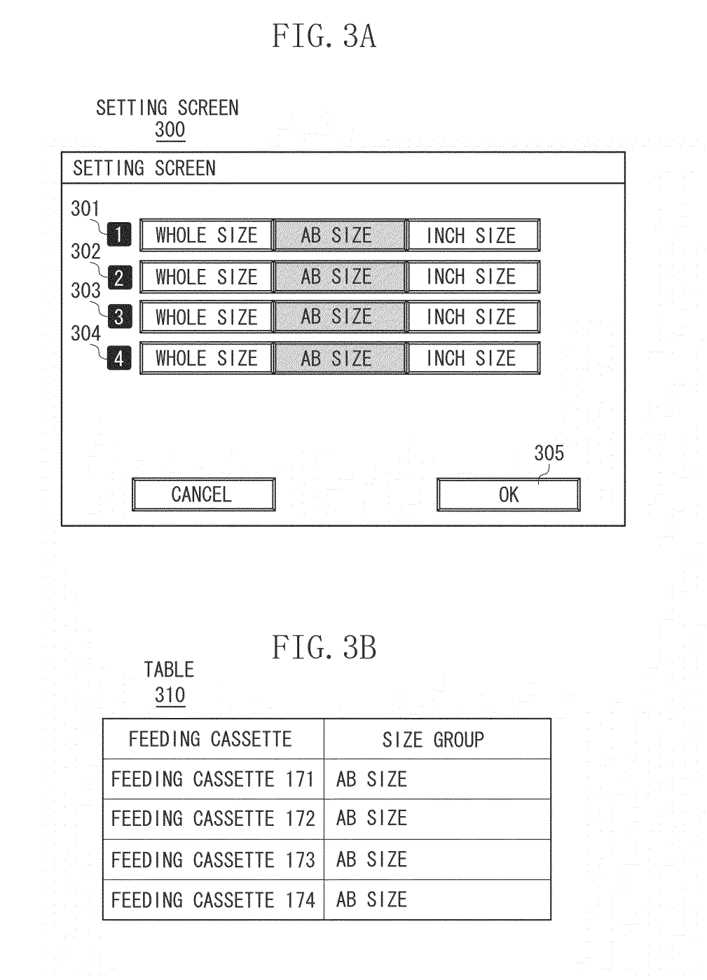

A setting screen 300 illustrated in FIG. 3A is displayed by the operation unit 150, on which the user sets the size group to be used to the feeding cassette. The setting screen 300 is presumed to be set by a system manager, but may be set by a general user.

Items 301 to 304 correspond to the feeding cassettes 171 to 174 respectively. On the setting screen 300, any of “whole size,” “AB size,” or “inch size” can be set as the group size.

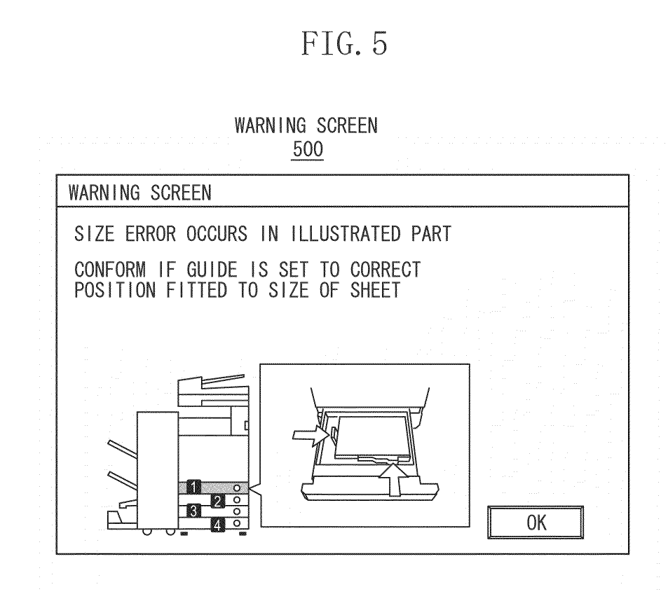

When the AB size, for example, is set to the feeding cassette 171, the printing apparatus 100 recognizes the feeding cassette 171 as a feeding cassette handling a sheet with the size included in the AB size. If the guide of the feeding cassette 171 is moved to the size position whose size is not included in the AB size, to the position of the LTR, for example, the printing apparatus 100 displays a warning screen illustrated in FIG. 5. The warning screen causes the user to know that the guide of the feeding cassette lies in an inappropriate size position. In a case where the sheet with the size included in the AB size is often used, it is recommendable that the AB size is set to the feeding cassette.

When the inch size, for example, is set to the feeding cassette 172, the printing apparatus 100 recognizes the feeding cassette 172 as a feeding cassette handling a sheet with the size included in the inch size. If the guide of the feeding cassette 172 is moved to the size position whose size is not included in the inch size, to the position of the A3, for example, the printing apparatus 100 displays the warning screen illustrated in FIG. 5. The warning screen causes the user to know that the guide of the feeding cassette lies in an inappropriate size position. In a case where the sheet with the size included in the inch size is often used, it is recommendable that the inch size is set to the feeding cassette.

When the whole size, for example, is set to the feeding cassette 173, the printing apparatus 100 recognizes the feeding cassette 173 as a cassette which does not restrict a sheet size to be handled. In other words, the printing apparatus 100 recognizes the size indicated by the guide of the feeding cassette as the size of the sheet stored in the feeding cassette as is. In a case where the sheets of both the AB size and the inch size are often used, it is recommendable that the whole size is set to the feeding cassette.

The setting screen 300 indicates that the AB size is specified as the size group by the user on all the feeding cassettes. When the user selects an OK button 305, the information set on the setting screen 300 is accumulated in the HDD 114 as setting information.

A table 310 illustrated in FIG. 3B is the one for storing the information set on the setting screen 300 and is stored in the HDD 114. The table 310 indicates an example of a state where the AB size is set as the size group to all the feeding cassettes 171 to 174.

The setting screen 300 shows an example in which the user individually sets the size groups to a plurality of the feeding cassettes, however, the user may collectively set the size groups to a plurality of the feeding cassettes.

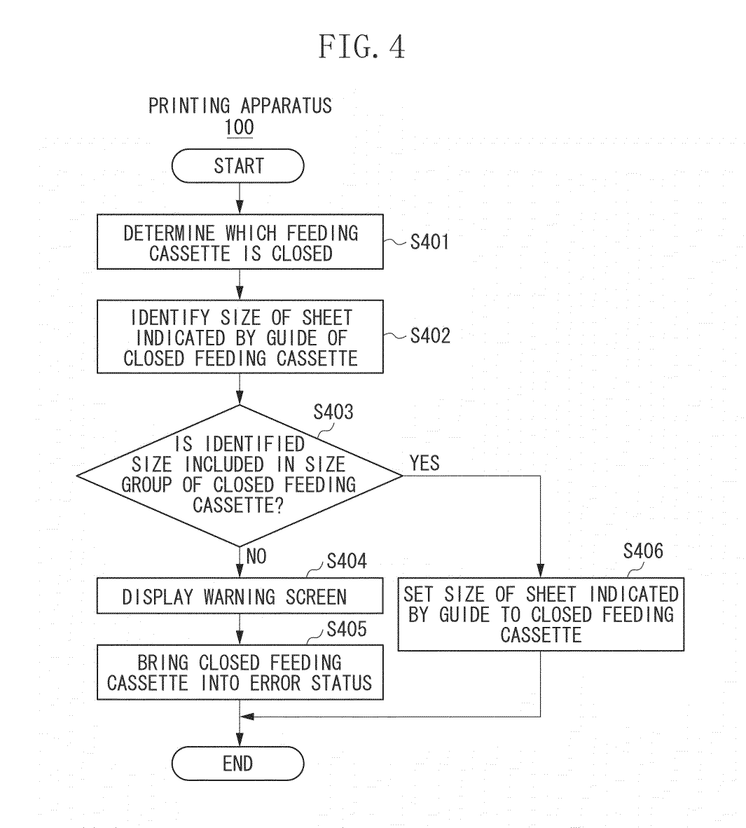

When the user exchanges the sheet on the feeding cassette or confirms the position of the guide of the feeding cassette, the user opens and closes the feeding cassette. FIG. 4 is a flow chart illustrating processing executed by the printing apparatus 100 when any of the feeding cassettes 171 to 174 is closed. Each step in the flow chart illustrated in FIG. 4 is processed by the CPU 111 loading a control program stored in the memory such as the ROM 112 on the RAM 113.

In step S401, the CPU 111 determines a feeding cassette which has been closed, among a plurality of the feeding cassettes. The determination is made based on the notification from the sheet feeding unit 170 via the sheet feeding unit control unit 115. The following description uses the feeding cassette 171 as an example of the closed feeding cassette.

In step S402, the CPU 111 identifies the size of the sheet indicated by the guide of the closed feeding cassette. If the guide of the feeding cassette 171 lies in the A3 position, for example, the CPU 111 identifies the size of the sheet as A3.

In step S403, the CPU 111 determines whether the size of the sheet identified in step S402 is included in the size group of the closed feeding cassette. The size group of the closed feeding cassette can be identified by the CPU 111 with reference to the table 310. If the CPU 111 determines that the size of the sheet identified in step S402 is included in the size group of the closed feeding cassette (YES in step S403), the processing proceeds to step S406. If the CPU 111 determines that the size of the sheet identified in step S402 is not included in the size group of the closed feeding cassette (NO in step S403), the processing proceeds to step S404.

For example, assume that the size of the sheet identified in step S402 is the A3 and the size group of the feeding cassette 171 is the AB size. In this case, the CPU 111 determines that the size of the sheet identified in step S402 is included in the size group of the closed feeding cassette, and the processing proceeds to step S406. On the other hand, assume that the size of the sheet identified in step S402 is the LTR and the size group of the feeding cassette 171 is the AB size. In this case, the CPU 111 determines that the size of the sheet identified in step S402 is not included in the size group of the closed feeding cassette, and the processing proceeds to step S404. If the size group of the feeding cassette 171 is the whole size, the processing proceeds to step S406.

Step S404 is described below. In step S404, the operation unit 150 displays the warning screen. A warning screen 500 illustrated in FIG. 5 is an example of the warning screen displayed in step S404 that notifies the user that an error related to the size of the sheet has occurred. The warning screen 500 urges the user to confirm the position of the guide of the feeding cassette. For example, if the size indicated by the guide of the feeding cassette is the LTR, the user may mistakenly set the guide to the LTR position instead of the A4 position even though the AB size is set to the feeding cassette 171 as the size group. The warning screen 500 is displayed in this situation to cause the user to notice that the guide of the feeding cassette lies in the size position unintended by the user.

In step S405, the CPU 111 brings the closed feeding cassette into an error status. This is because the feeding cassette which may lie in the size position unintended by the user, should not be used for printing.

Step S406 is described below. In step S406, the CPU 111 sets the size indicated by the guide to the closed feeding cassette.

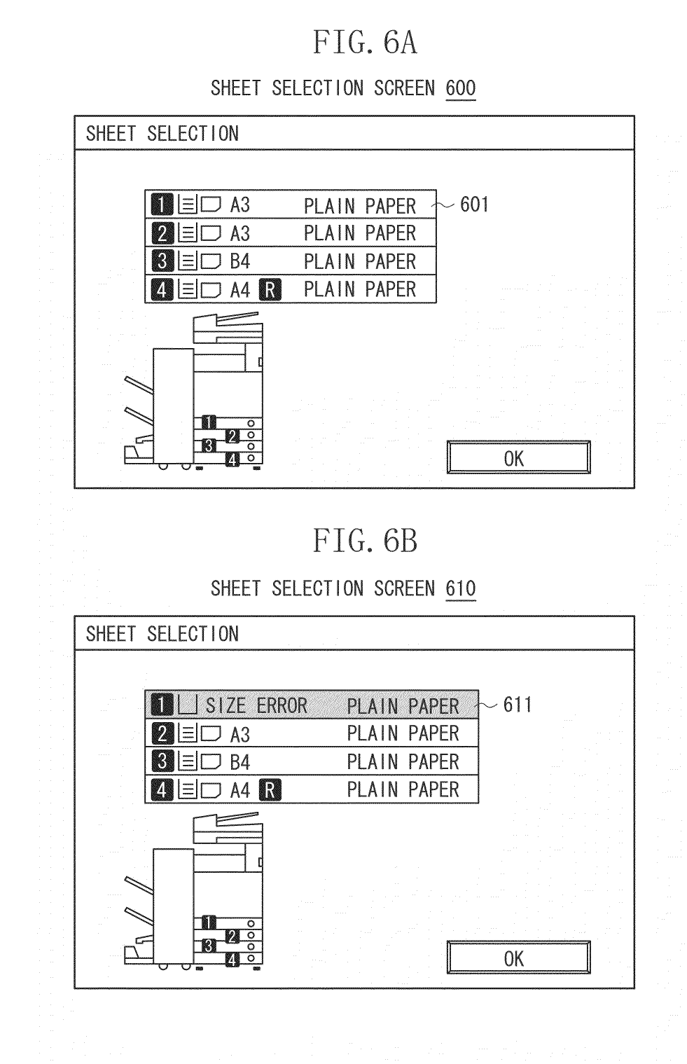

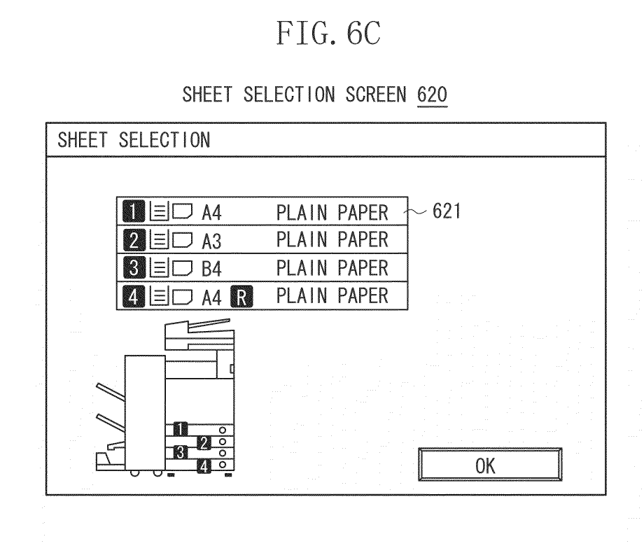

A screen transition on the operation unit 150 is described below with reference to FIGS. 6A, 6B, and 6C. A sheet selection screen 600 illustrated in FIG. 6A is displayed on the operation unit 150. The sheet selection screen 600 is the one used for selecting a sheet to be used for printing and displayed at the time of using a copy function of the printing apparatus 100, for example. The AB size is already set as the size group to the feeding cassette 171.

Assume that the user opens the feeding cassette 171 (an item 601 corresponds to the feeding cassette 171), moves the guide of the feeding cassette 171 from the A3 position to the LTR position, and closes the feeding cassette 171 while the operation unit 150 displays the sheet selection screen 600. Because the LTR is not included in the AB size, the operation unit 150 displays the warning screen 500 illustrated in FIG. 5 when the user closes the feeding cassette 171. The warning screen 500 causes the user to know that the guide of the feeding cassette lies in an inappropriate size position.

When the warning screen 500 is displayed, the sheet selection screen 610 illustrated in FIG. 6B is displayed. It can be seen from an item 611 that the feeding cassette 171 is in an error status which prevents use of the feeding cassette 171 for printing.

An example is described below in which the user opens the feeding cassette 171, moves the guide of the feeding cassette 171 from the A3 position to the A4 position, and closes the feeding cassette 171. In this case, the A4 is included in the AB size, so that the warning screen 500 is not displayed and the sheet selection screen 620 illustrated in FIG. 6C is displayed on the operation unit 150. It can be seen from an item 621 that the A4 indicated by the guide is set to the feeding cassette 171.

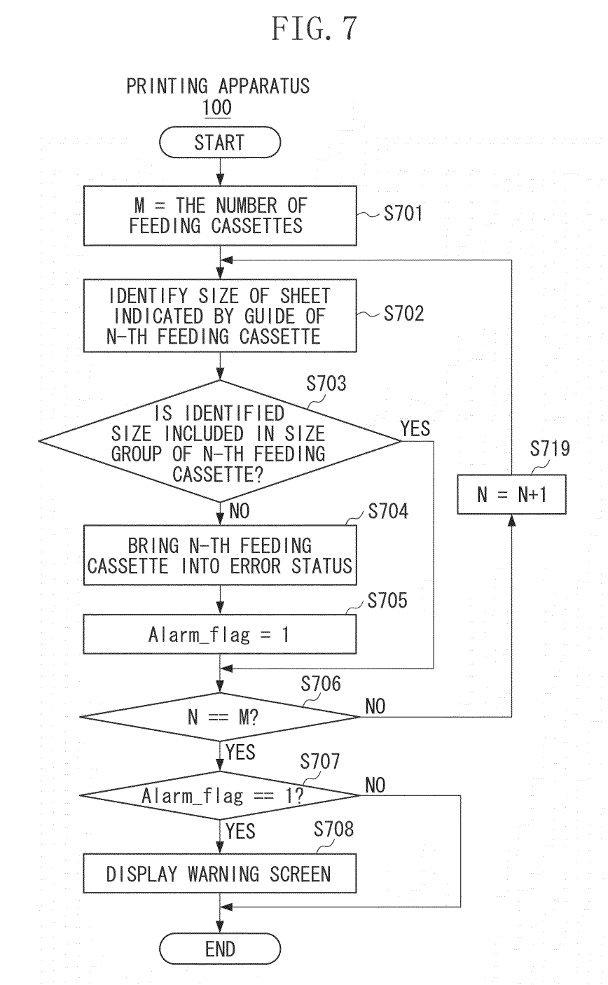

The flow chart illustrated in FIG. 4 describes the processing for displaying the warning screen 500 when the user closes the feeding cassette. However, the timing of displaying the warning screen 500 is not limited to the timing of closing the feeding cassette by the user. An example in which the warning screen 500 is displayed at a different timing is described below using a flow chart illustrated in FIG. 7.

The flow chart illustrated in FIG. 7 shows a processing executed at the time of selecting the OK button 305 (or touching a touch panel) on the setting screen 300 illustrated in FIG. 3A. Each step in the flow chart illustrated in FIG. 7 is processed by the CPU 111 loading a control program stored in the memory such as the ROM 112 on the RAM 113.

If the size group set to the feeding cassette is changed on the setting screen 300, the size indicated by the guide may not be included in the changed size group. The flow chart in FIG. 7 illustrates processing for displaying the warning screen 500 in this case.

When the OK button 305 is selected on the setting screen 300, in step S701, the CPU 111 initializes a variable. More specifically, 1 is substituted for a variable N, the number of the feeding cassettes (4 in the present exemplary embodiment) is substituted for a variable M, and 0 is substituted for a variable Alarm_flag.

In step S702, the CPU 111 identifies the size of the sheet indicated by the guide of the N-th feeding cassette. In the present exemplary embodiment, the first, second, third, and fourth feeding cassettes correspond to the feeding cassettes 171 to 174 in this order.

In step S703, the CPU 111 determines whether the size of the sheet identified in step S702 is included in the size group of the N-th feeding cassette. If the CPU 111 determines that the size of the sheet identified in step S702 is not included in the size group of the N-th feeding cassette (NO in step S703), the processing proceeds to step S704. For example, if the size of the sheet identified in step S702 is the A4, and the size group of the N-th feeding cassette is the inch size, the processing proceeds to step S704. If the CPU 111 determines that the size of the sheet identified in step S702 is included in the size group of the N-th feeding cassette, the processing proceeds to step S706. For example, if the size of the sheet identified in step S702 is the A4, and the size group of the N-th feeding cassette is the AB size, the processing proceeds to step S706.

Step S704 is described below. In step S704, the CPU 111 brings the N-th feeding cassette into an error status. In step S705, the CPU 111 substitutes 1 for the variable Alarm_flag.

Step S706 is described below. In step S706, the CPU determines whether the value of the variable N is equal to the variable M. If the value of the variable N is unequal to the variable M (NO in step S706), this means that the check of all the feeding cassettes is not completed. Therefore, in step S706, if the CPU 111 determines that the value of the variable N is unequal to the variable M, the processing proceeds to step S719 and the CPU 111 increases the value of the variable N by 1. The processing in steps S702 to S706 is repeated until the check of all the feeding cassettes is completed.

Step S707 is described below. In step S707, the CPU 111 determines whether the value of the variable Alarm_flag is equal to 1. If the value of the variable Alarm_flag is equal to 1 (YES in step S707), this means that a guide of at least one feeding cassette lies in an inappropriate position. Then, the processing proceeds to step S708 and the operation unit 150 displays a warning screen (the warning screen 500 in FIG. 5, for example). If the value of the variable Alarm_flag is not equal to 1 (NO in step S707), this means that a guide of each feeding cassette lies in an appropriate position. Therefore, the processing illustrated in FIG. 7 is finished without the warning screen being displayed.

As described above, the printing apparatus 100 displays the warning screen, provided that the size of the sheet indicated by the guide of a feeding cassette is not included in the size group set to the feeding cassette. Therefore, according to the present exemplary embodiment, the user can recognize that the guide of the feeding cassette lies in an inappropriate position.

When, the size positions of the A4 and the LTR, for example, are close to each other, the user may be misled into thinking that the guide lies in the A4 position even though the guide actually lies in the LTR position. According to the present exemplary embodiment, if a system manager previously sets the AB size as the size group to the feeding cassette, the user can be prevented from being misled because the warning screen can be displayed when the guide lies in the LTR position.

A second exemplary embodiment is described below. The first exemplary embodiment describes two examples of the AB size and the inch size in addition to the whole size as the size group which can be set to the feeding cassette. However, a size group is not limited to these groups but may use other different groups, and the number of size groups may be increased.

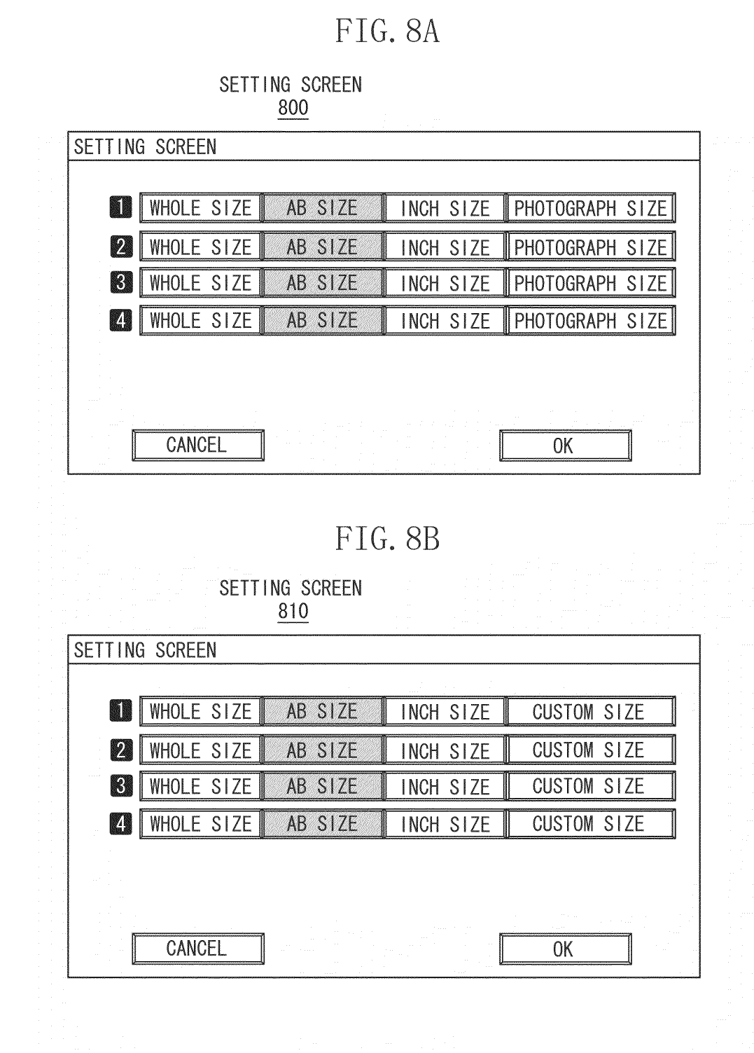

A setting screen 800 in FIG. 8A is a screen illustrating a first modification example of a size group. A photograph size is added to the setting screen 300 as a candidate for the size group. The photograph size handles a size related to a photograph such as L size and 2L size as one group.

A setting screen 810 in FIG. 8B is a screen illustrating a second modification example of a size group. A custom size is added to the setting screen 300 as a candidate for the size group. The custom size is an icon for setting a size group freely formed by the user on an editing screen (not illustrated) to the feeding cassette. The user can freely form the size group using the custom size.

According to exemplary embodiments of the present invention, the user can realize that the guide for detecting the size of the sheet lies in an inappropriate position.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-029733, filed Feb. 19, 2014, which is hereby incorporated by reference herein in its entirety.

What is claimed is:

1. A printing apparatus comprising:
a sheet holding unit including a movable guide and configured to hold a sheet;
a setting unit configured to set a size group covering a plurality of sheet sizes as one group to the sheet holding unit;
a determination unit configured to determine whether the sheet size identified by the guide is included in the size group set by the setting unit; and
a notification unit configured to notify a user of a predetermined information if the determination unit determines that the sheet size identified by the guide is not included in the size group.

2. The printing apparatus according to claim 1, wherein the setting unit sets the size group specified by the user among a plurality of size groups including at least a first size group and a second size group different from the first size group, to the sheet holding unit.

3. The printing apparatus according to claim 2, further comprising a display unit configured to display a setting screen on which the user specifies the size group to be set to the sheet holding unit from among the plurality of size groups, wherein the setting unit sets the size group specified by the user via the setting screen to the sheet holding unit.

4. The printing apparatus according to claim 1, wherein the determination unit determines whether the sheet size identified by the guide is included in the size group if the sheet holding unit is closed.

5. The printing apparatus according to claim 1, wherein the printing apparatus includes a plurality of the sheet holding units to which size groups can be set and the setting unit sets the size groups to each of the plurality of the sheet holding units to which the size groups can be set.

6. The printing apparatus according to claim 1, wherein the guide is movable along a rail provided on the sheet holding unit, the printing apparatus further includes an identification unit configured to identify the sheet size of the sheet held by the sheet holding unit, and the determination unit determines whether the sheet size identified by the identification unit is included in the size group.

7. The printing apparatus according to claim 1, wherein the notification unit displays a warning screen indicating that an error related to the sheet size has occurred.

8. A printing apparatus comprising:
a sheet holding unit including a movable guide and configured to hold a sheet;
a setting unit configured to set a plurality of sheet sizes to the sheet holding unit;
a determination unit configured to determine whether the sheet size identified by the guide corresponds to any of the plurality of sheet sizes set by the setting unit; and
a notification unit configured to notify a user of a predetermined information if the determination unit determines that the sheet size identified by the guide does not correspond to any of the plurality of sheet sizes set by the setting unit.

9. The printing apparatus according to claim 8, wherein, the determination unit determines whether the sheet size identified by the guide corresponds to any of the plurality of sheet sizes in a case where the sheet holding unit is closed.

10. The printing apparatus according to claim 8, wherein the guide is movable along a rail provided on the sheet holding unit, the printing apparatus further includes an identification unit configured to identify the sheet size of the sheet held by the sheet holding unit based on the position of the guide, and the determination unit determines whether the sheet size identified by the identification unit corresponds to any of the plurality of sheet sizes.

11. The printing apparatus according to claim 8, wherein the notification unit displays a warning screen indicating that an error related to the sheet size has occurred.
